(19) United States
(12) Patent Application Publication
(10) Pub. No.: US 2025/0374191 A1
(43) Pub. Date: Dec. 4, 2025

(54) PDCCH SKIPPING WITHOUT CHANNEL ASSIGNMENTS AND ON MULTIPLE COMPONENT CARRIERS

(71) Applicant: QUALCOMM Incorporated, San Diego, CA (US)

(72) Inventors: Fang YUAN, Beijing (CN); Iyab Issam SAKHNINI, San Diego, CA (US); Wooseok NAM, San Diego, CA (US); Tao LUO, San Diego, CA (US)

(21) Appl. No.: 18/877,971

(22) PCT Filed: Aug. 11, 2022
(86) PCT No.: PCT/CN2022/111751

§ 371 Date: Dec. 20, 2024

(51) Int. Cl. H04W 52/02; H04W 72/232; H04W 76/28

(52) U.S. Cl. CPC H04W 52/0235; H04W 72/232; H04W 76/28

(57) ABSTRACT

Systems, methods, and apparatuses for PDCCH skipping without channel assignments and on multiple component carriers are provided. An apparatus is configured to receive a configuration for DRX and to receive DCI within a DRX active time. The DCI indicates for the UE to skip PDCCH monitoring for a duration of time within the DRX active time and without a resource assignment for downlink or uplink. The UE is configured to skip monitoring for a PDCCH during the duration of time. Another apparatus is configured to receive a configuration indicating to apply PDCCH skipping to a component carriers(s) and to receive DCI in a component carrier indicating for the UE to skip PDCCH monitoring for a duration of time. The other apparatus is configured to skip monitoring for a PDCCH during the duration of time in the one or more component carriers based on the configuration.

### TECHNICAL FIELD

The present disclosure relates generally to communication systems, and more particularly, to wireless communication including monitoring for a physical downlink control channel (PDCCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to perform operations, including but without limitation, to receive a configuration for discontinuous reception (DRX), to receive downlink control information (DCI) within a DRX active time, the DCI indicating for the UE to skip physical downlink control channel (PDCCH) monitoring for a duration of time within the DRX active time and without a resource assignment for downlink or uplink, and to skip monitoring for a PDCCH during the duration of time.

In another aspect of the disclosure, a method, a computer-readable medium, and an apparatus are provided for wireless communication at a UE. The apparatus is configured to perform operations, including but without limitation, to receive a configuration indicating to apply PDCCH skipping to one or more component carriers, to receive DCI in a component carrier indicating for the UE to skip PDCCH monitoring for a duration of time, and to skip monitoring for a PDCCH during the duration of time in the one or more component carriers based on the configuration.

In still another aspect of the disclosure, a method, a computer-readable medium, and an apparatus are provided for wireless communication at a network node. The apparatus is configured to perform operations, including but without limitation, to configure a UE for DRX, to transmit DCI to the UE within a DRX active time, the DCI indicating for the UE to skip PDCCH monitoring for a duration of time within the DRX active time and without a resource assignment for downlink or uplink, and to skip transmission of a PDCCH during the duration of time.

In yet another aspect of the disclosure, a method, a computer-readable medium, and an apparatus are provided for wireless communication at a network node, in aspects. The apparatus is configured to perform operations, including but without limitation, to configure a UE to apply PDCCH skipping to one or more component carriers, to transmit DCI in a component carrier indicating for the UE to skip PDCCH monitoring for a duration of time, and to skip transmission of a PDCCH during the duration of time in the one or more component carriers based on the configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic, in accordance with various aspects of the present disclosure.

FIG. 5 is a diagram illustrating an example timeline of discontinuous reception (DRX) cycles in a UE for a physical downlink control channel (PDCCH), in accordance with various aspects of the present disclosure.

FIG. 6 is a diagram illustrating an example of dynamic continuous DRX (C-DRX) parameter adaptation, in accordance with various aspects of the present disclosure.

FIG. 7 is a diagram illustrating an example of dynamic C-DRX for XR data bursts, in accordance with various aspects of the present disclosure.

FIG. 8 is a call flow diagram for wireless communications, in accordance with various aspects of the present disclosure.

FIG. 9 is a diagram for non-scheduling downlink control information (DCI) for a PDCCH skipping indication, in accordance with various aspects of the present disclosure.

FIG. 10 is a diagram for a PDCCH skipping indication for a set of component carriers (CCs), in accordance with various aspects of the present disclosure.

FIGS. 11A and 11B are flowcharts of methods of wireless communication, in accordance with various aspects of the present disclosure.

FIGS. 12A and 12B are flowcharts of methods of wireless communication, in accordance with various aspects of the present disclosure.

FIG. 13 is a diagram illustrating an example of a hardware implementation for an example apparatus and/or UE, in accordance with various aspects of the present disclosure.

FIG. 14 is a diagram illustrating an example of a hardware implementation for an example network entity, in accordance with various aspects of the present disclosure.

### DETAILED DESCRIPTION

Wireless communication, e.g., including monitoring for wireless signals, by a user equipment may consume power (e.g., battery power) at the UE. Battery power may be conserved, e.g., in some aspects, through discontinuous reception (DRX) in which a UE monitors for control signaling such as a PDCCH discontinuously using an ON and OFF pattern. In some aspects, battery power may be conserved through PDCCH skipping in which a UE receives downlink control information (DCI) scheduling uplink or downlink communication and including an indication to skip PDCCH monitoring for a duration of time. Aspects presented herein provide more efficient power saving through PDCCH skipping without channel assignments and/or PDCCH skipping on multiple component carriers. Currently, for “on durations” of active discontinuous reception cycles, download and/or upload assignments are required to be made, which requires power of the user equipment to perform. Additionally, PDCCH skipping downlink control information is only indicated for a single component carrier. The described aspects provide for power reductions during continuous discontinuous reception on durations via physical downlink control channel skipping downlink control information that specifies a portion of physical downlink control channel monitoring to be skipped in the on duration without uplink or downlink assignments. The described aspects also provide for PDCCH skipping downlink control information that specifies one or more component carriers in carrier aggregation from a single received instance of downlink control information in a single control channel.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

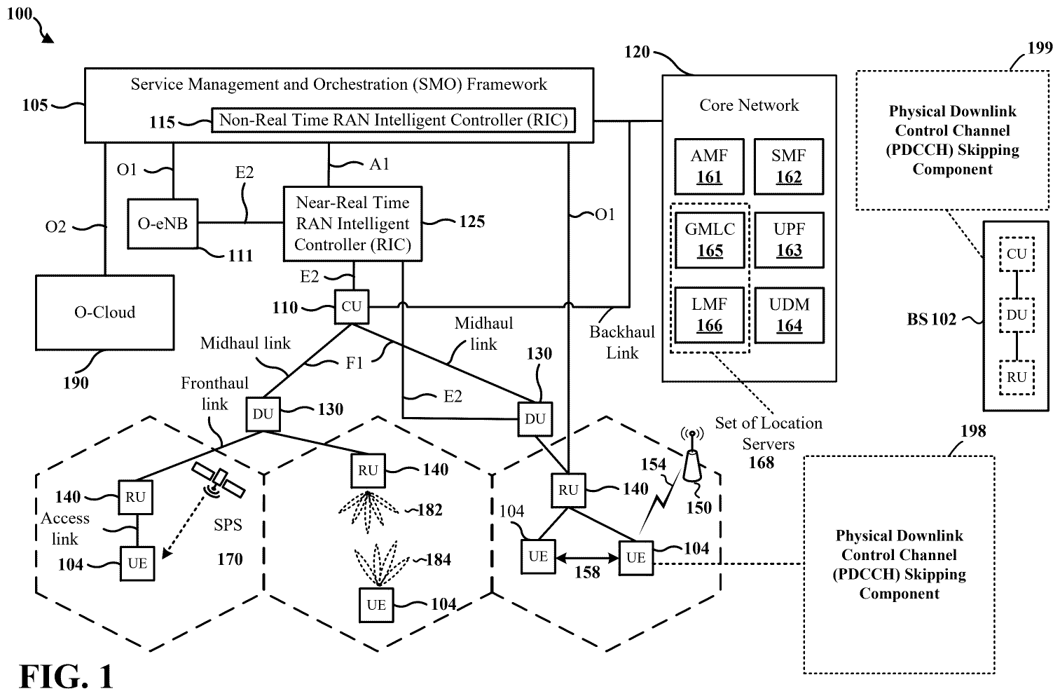

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a PDCCH skipping component 198 that is configured to receive a configuration for DRX, to receive DCI within a DRX active time, the DCI indicating for the UE to skip physical downlink control channel (PDCCH) monitoring for a duration of time within the DRX active time and without a resource assignment for downlink or uplink, and to skip monitoring for a PDCCH during the duration of time. In some aspects, the PDCCH skipping component 198 may be configured to receive a configuration indicating to apply PDCCH skipping to one or more component carriers, to receive DCI in a component carrier indicating for the UE to skip PDCCH monitoring for a duration of time, and to skip monitoring for a PDCCH during the duration of time in the one or more component carriers based on the configuration.

In some aspects, a base station 102, or one or more components of a base station such as CU 110, DU 130, or RU 140, may include a PDCCH skipping component 199 that is configured to configure a UE for DRX, to transmit DCI to the UE within a DRX active time, the DCI indicating for the UE to skip PDCCH monitoring for a duration of time within the DRX active time and without a resource assignment for downlink or uplink, and to skip transmission of a PDCCH during the duration of time. In some aspects, the PDCCH skipping component 199 may be configured to configure a UE to apply PDCCH skipping to one or more component carriers, to transmit DCI in a component carrier indicating for the UE to skip PDCCH monitoring for a duration of time, and to skip transmission of a PDCCH during the duration of time in the one or more component carriers based on the configuration. Although the following description may be focused on 5G NR, the concepts described herein may be applicable to other similar areas, such as LTE, LTE-A, CDMA, GSM, and other wireless technologies.

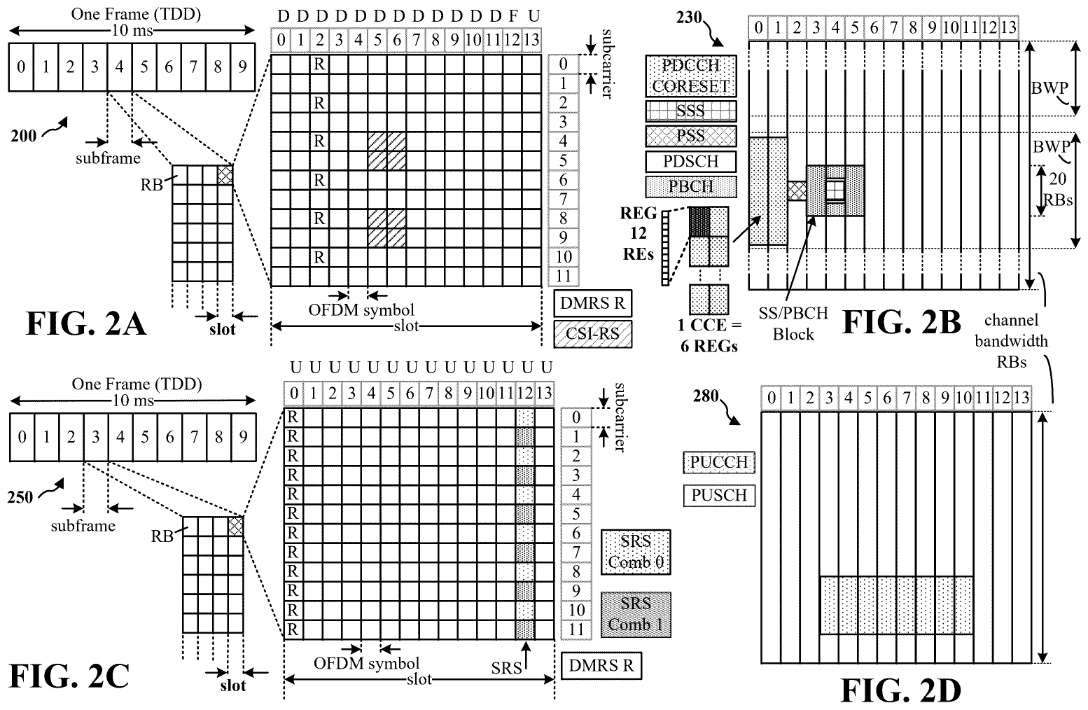

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

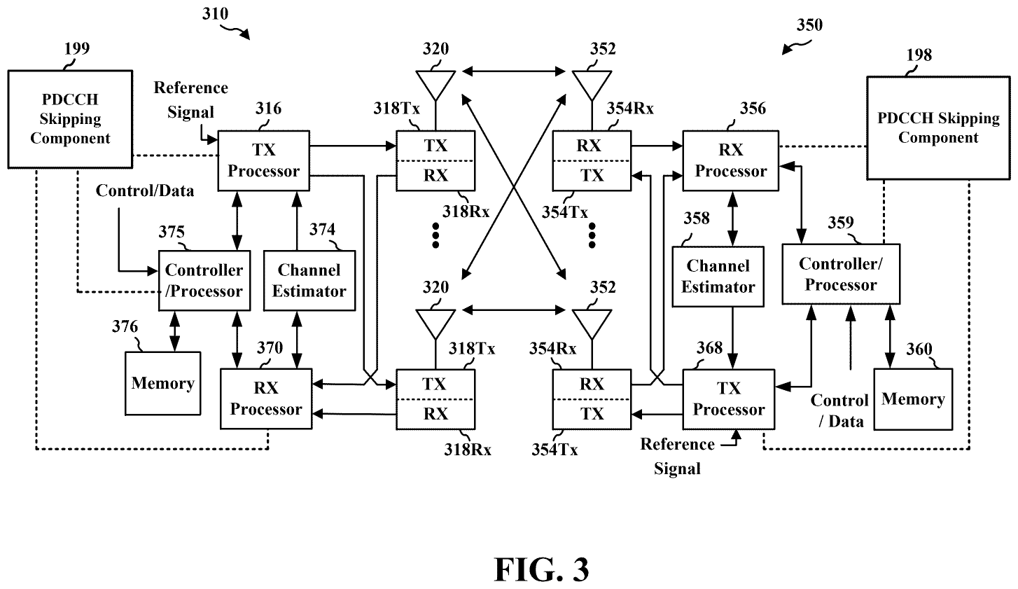

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDCCH skipping component 198 of FIG. 1.

At least one of the TX processor 316, the RX processor 370, and the controller/processor 375 may be configured to perform aspects in connection with the PDCCH skipping component 199 of FIG. 1.

Various aspects herein relate to PDCCH skipping without channel assignments and on multiple component carriers. While various aspects may be described in the context of extended reality (XR) for descriptive and illustrative purposes, aspects are not so limited and are applicable to other types of traffic and/or data, as would be understood by persons of skill in the relevant art(s) having the benefit of this disclosure.

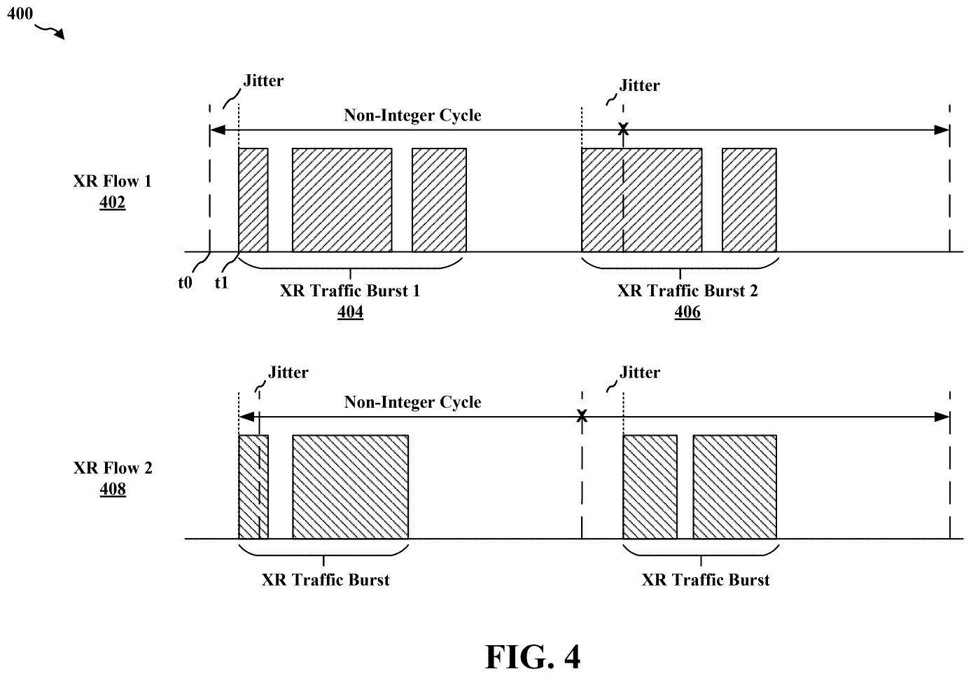

FIG. 4 is a diagram 400 illustrating example XR traffic. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

XR traffic may have an associated packet delay budget (PDB). If a packet does not arrive within the PDB, a UE (or a base station) may discard the packet. In an example, if a packet corresponding to a video frame of a video does not arrive at a UE within a PDB, the UE may discard the packet, as the video has advanced beyond the frame.

In general, XR traffic may be characterized by relatively high data rates and low latency. The latency in XR traffic may affect the user experience. For instance, XR traffic may have applications in eMBB and URLLC services.

Some types of wireless communication systems may employ dynamic grants for scheduling purposes to accommodate traffic (e.g., XR traffic). In a dynamic grant, a scheduler may use control signaling to allocation resources for transmission or reception at a UE (e.g., a grant of UL or DL resources). Dynamic grants may be flexible and can adopt to variations in traffic behavior. A UE may monitor for a PDCCH including a DCI that schedules the UE to transmit or receive communication with a base station (e.g., instructions to receive data over a PDSCH). However, monitoring for a PDCCH consumes power at the UE, and can increase latency in communication between the UE and the base station as the UE waits for a resource assignment to transmit or receive communication.

Various aspects may be employed to provide power saving and/or capacity improvement for wireless communication, e.g., including XR traffic. In some aspects, scheduling mechanisms such as SPS or a CG may be used to provide periodic resources for UL or DL communication that can be used without a dynamic grant of resources. The SPS or CG scheduling may be configured to accommodate the periodic traffic, multiple flows, jitter, latency, and reliability for the wireless traffic and may improve capacity and/or latency for such wireless communication. Aspects presented herein provide for PDCCH monitoring, which may be applied with DRX, that saves power at the UE and accommodates periodic traffic, multiple flows, jitter, latency, and reliability for the wireless traffic such as XR traffic among other examples.

Traffic bursts, such as XR bursts by way of example, are periodic and may include some time jitter in the arrival. In some aspects, a PDCCH skipping DCI may be transmitted by a network and received by a UE to schedule DL or UL transmissions and to adjust the starting time and length of CDRX “on duration.” That is, for on durations of active DRX cycles, DL and/or UL assignments are made, which requires power of the UE to perform. The PDCCH skipping DCI indicates the PDCCH skipping for one CC, e.g., the CC in which the DCI is received, whereas XR may operate in multiple CCs using carrier aggregation (CA). Aspects presented herein provide for more efficient PDCCH skipping by enabling a single PDCCH skipping indication to be transmitted in a single CC and to be applied to multiple CCs, which enables increased power savings with reduced overhead and DCI reception. Aspects herein enable and support PDCCH skipping DCI without DL or UL assignment, and also enable and support PDCCH skipping DCI indicating PDCCH skipping for multiple CCs in CA. Accordingly, aspects herein provide for power reductions for C-DRX on durations via 1) PDCCH skipping DCI that specifies a portion of PDCCH monitoring to be skipped in the on duration without UL and DL assignments, and/or 2) PDCCH skipping DCI that specifies one or more CCs in CA.

In an example configuration, an apparatus is configured to receive a configuration for discontinuous reception DRX, and to receive DCI within a DRX active time. The DCI indicates for the UE to skip PDCCH monitoring for a duration of time within the DRX active time and without a resource assignment for downlink or uplink. The DCI enables the UE to skip monitoring for a PDCCH during the duration of time without UL/DL transmissions, even though the skipping occurs during the active time of the DRX on duration, and this skipping reduces power consumption for each DRX cycle for which it is applied. As discussed below, in another example configuration, an apparatus is configured to receive a configuration indicating to apply PDCCH skipping to a number of CCs, and to receive DCI in one CC indicating for the UE to skip PDCCH monitoring for a duration of time. That is, the DCI enables the UE to skip monitoring for a PDCCH during the duration of time in a number of CCs based on the configuration, rather than being limited to a single CC associated with the PDCCH in which the DCI is received. This skipping over multiple CCs further reduces power consumption for each DRX cycle over any number of CCs while the DCI is only provided for a single CC.

By way of example in the context of XR, traffic (both UL and DL) characteristics, QOS metrics, and application layer attributes are beneficial for the network to be aware of to increase efficiency and decrease power consumption at the UE. Aspects herein take the above information into account to aid traffic handling (e.g., XR-specific traffic handling). Power saving aspects enable power saving techniques that accommodate service characteristics (e.g., periodicity, multiple flows, jitter, latency, reliability, etc.), including but not limited to XR service characteristics, and provide for C-DRX enhancements and PDCCH monitoring enhancements. Aspects for capacity improvements, including by not limited to XR-specific capacity improvements, provide more efficient resource allocation and scheduling for service characteristics (e.g., periodicity, multiple flows, jitter, latency, reliability, etc.). and provide for semi-persistent scheduling (SPS) and configured grant(s) (CG(s)) enhancements, as well as dynamic scheduling and/or grant enhancements.

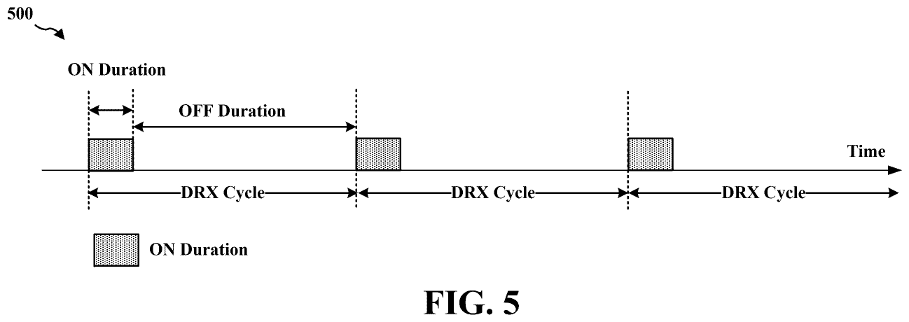

FIG. 5 shows a diagram 500 illustrating an example timeline of discontinuous reception (DRX) cycles in a UE. A UE may be configured by a base station for discontinuous reception (DRX). During an RRC connected state, when there is no data transmission in either direction (UL/DL), the UE may operate using the DRX mode. In the DRX mode, the UE monitors the PDCCH channel discontinuously using a sleep and wake cycle, e.g., OFF durations and ON durations. When the UE is in an RRC connected state, the DRX may also be referred to as Connected Mode DRX (C-DRX). DRX conserves battery power at the UE. In a non-DRX mode, the UE monitors for PDCCH in each subframe to check whether there is downlink data available. Continuous monitoring of the PDCCH uses more battery power at the UE.

The UE may receive a DRX configuration from the network in RRC signaling from a base station, such as in an RRC Connection Setup request or an RRC connection reconfiguration request. A DRX configuration may include the configuration of one or more timers and values. In some examples, the DRX configuration may include any of an ON duration Timer, a DRX inactivity timer, a DRX retransmission timer, a DRX UL retransmission timer, a long DRX cycle, a value of the DRX slot offset, a DRX short cycle timer, and/or a short DRX cycle, among others. A DRX cycle may comprise a periodic repetition of an on duration in which the UE monitors for PDCCH from the base station and an off duration. As noted, FIG. 5 illustrates an example of a DRX cycles including periodic ON durations during which the UE monitors for PDCCH and OFF durations during which the UE may not monitor for the PDCCH. The OFF duration may be referred to as a DRX opportunity. During the OFF duration, the UE does not monitor for PDCCH. The UE may enter a sleep mode or a low power mode in which the UE minimizes power consumption by shutting down a radio frequency (RF) function without detecting communication from the base station.

The ON duration timer may correspond to a number of consecutive PDCCH subframes to be monitored or decoded when the UE wakes up from the OFF duration in the DRX Cycle. The DRX retransmission timer may correspond to a consecutive number of PDCCH subframes for the UE to monitor when a retransmission is expected by the UE. The DRX inactivity timer may correspond to an amount of time before the UE may again enter the OFF duration following successfully decoding PDCCH. The amount of time may be in terms of a transmission time interval (TTI) duration. After a UE successfully receives downlink data, the DRX Inactivity Timer may start counting a number of subframes. If any uplink or downlink data transmissions occur while the DRX inactivity timer is running, the timer restarts. If the DRX inactivity timer expires without uplink or downlink activity, the UE may enter the DRX cycle to achieve power savings.

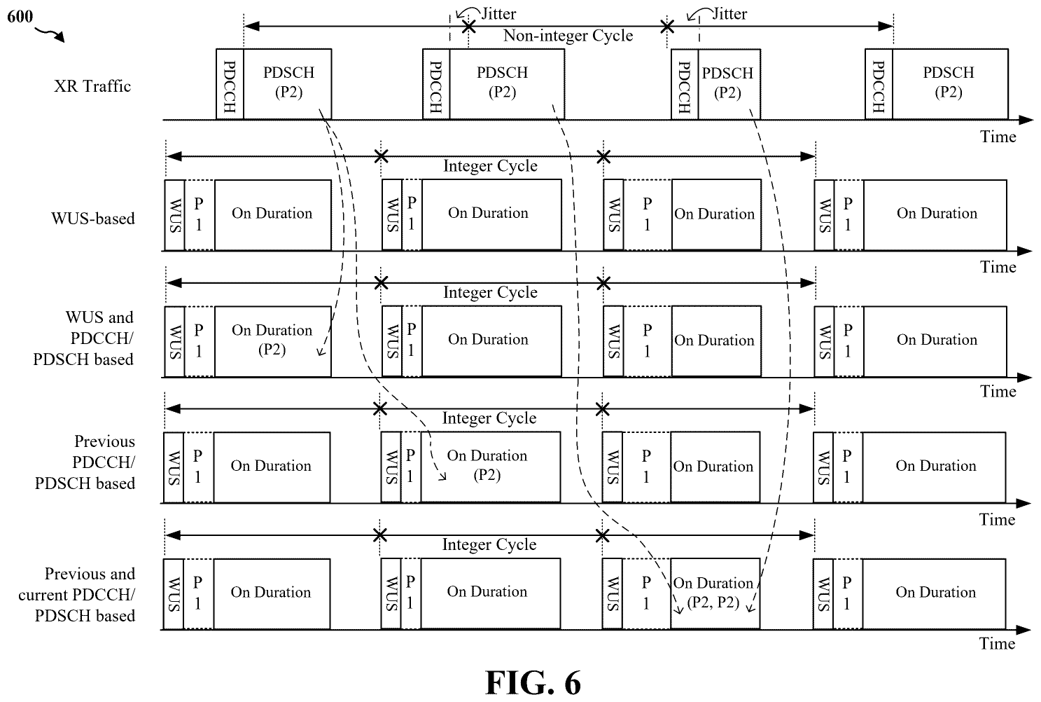

FIG. 6 is a diagram 600 illustrating an example of dynamic continuous DRX (C-DRX) parameter adaptation. Diagram 600 includes timelines of non-integer cycles for XR traffic and associated jitter for XR data arrival times, as well as four timelines of integer cycles in which enhancement of C-DRX on duration is provided. For instance, these parameter adaptation timelines illustrate integer cycles with a wake-up signal (WUS) that (e.g., of DCI, media access-control element (MAC-CE), etc.) is provided prior to the on duration portion of the integer cycle. The WUS in each timeline may specify the start time and/or the length of the on duration portion of the C-DRX cycle, allowing for adaptation of XR packet jitter, variable length, and/or the like. The four integer cycle timelines respectively show DRX parameter options for adaptation based at least on: WUS, WUS and PDDCH/PDSCH, previous PDDCH/PDSCH, and previous and current PDDCH/PDSCH. In aspects, C-DRX adaption may include WUS to C-DRX ON offset, C-DRX on duration, an inactivity timer, a retransmission timer, a sleep indication after last packet, a next WUS skipping, a scheduling additional WUS, etc.

The illustrated integer cycles each include a Part 1 (P1), which is after the WUS and before the on duration, and a Part 2 (P2), which is the on duration. Diagram 600 illustrates via dashed-curved arrows in which on durations a given XR burst may be carried. As noted above, XR bursts may vary in size/duration and/or arrival times, and accordingly, the on duration in which an XR burst is carried may vary.

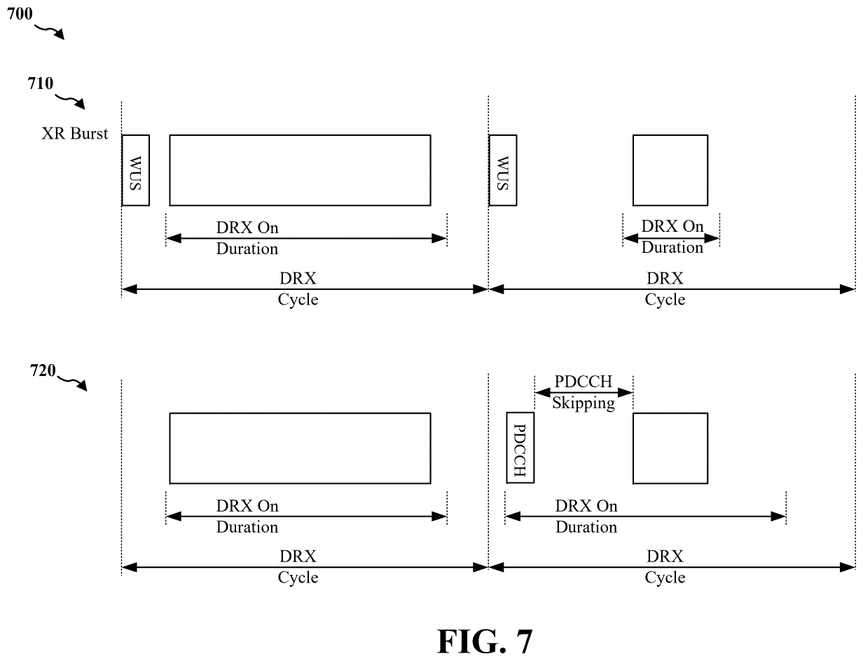

FIG. 7 is a diagram 700 illustrating an example of dynamic C-DRX. Diagram 700 may be a further aspect of diagram 600 in FIG. 6. The DRX cycles 710 are depicted as similarly described above in diagram 600 for WUS-based adaptations of starting time for on durations. In the diagram with the DRX cycles 710, a WUS is first provided/received before a DRX on duration in which further control signal (e.g., PDCCH) and data of the is provided/received. The WUS may indicate for the UE to delay a start of the DRX on duration, as illustrated for the second DRX cycle. As illustrated in the two DRX Cycles for XR bursts, the start time and/or the length of the on duration portion of the C-DRX cycle, in which XR burst data is present, varies for PDCCH monitoring. In the first DRX cycle, the WUS does not indicate a delay to the DRX on duration. The first DRX cycle provides for a relatively long on duration for PDCCH monitoring that begins a time period after the WUS. In the second DRX cycle, the WUS indicates a delay to the DRX on duration. The WUS in the second DRX cycle provides for a relatively short on duration for monitoring that begins later after the WUS. As the UE skips monitoring for PDCCH in the DRX off duration, the delay in the DRX in duration provides a time during which the UE does not monitor for a PDCCH.

The DRX cycles 720 include a DCI that indicates for the UE to skip PDCCH monitoring for a duration of time. In contrast to the WUS that is received prior to the DRX on duration in the DRX cycles 710, the PDCCH is received during the DRX on duration and indicates a duration for the UE to skip PDCCH monitoring within the DRX on duration. In the DRX cycles 720, the first DRX cycle includes a relatively longer on duration for PDCCH monitoring, while the second DRX cycle includes a portion of PDCCH monitoring being skipped in the on duration.

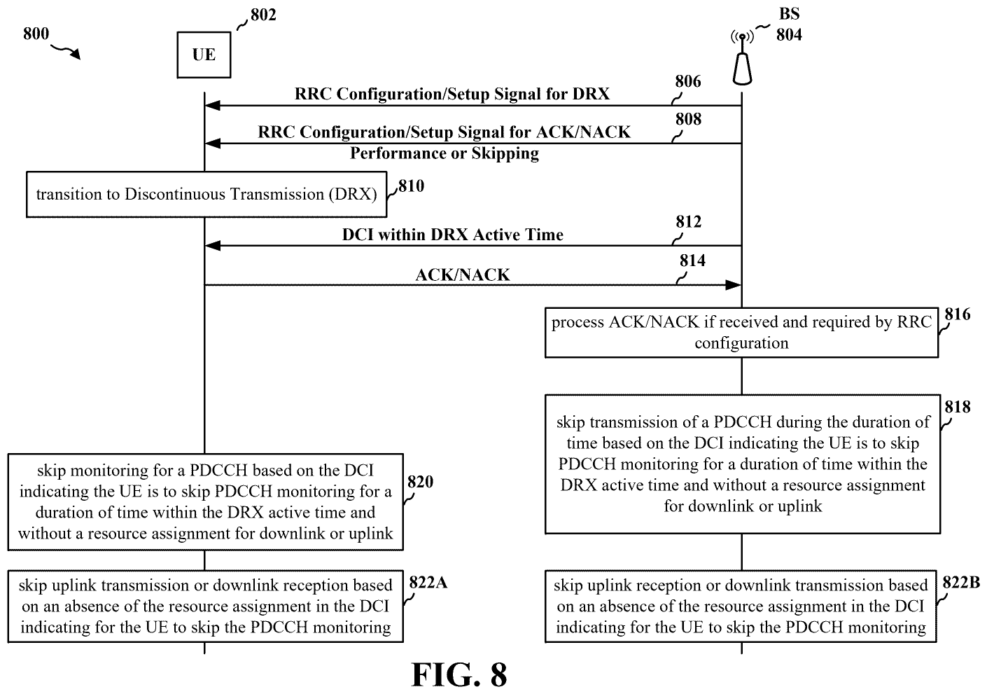

FIG. 8 is an example of a call flow diagram 800 of wireless communications. Call flow diagram 800 illustrates PDCCH skipping without channel assignments. In the illustrated aspect, a UE 802 receives, from a network entity 804 (e.g., a base station or one or more components of a base station such as a CU, DU, and/or RU), a configuration 806 for DRX. The UE transitions to DRX, at 810, based on the configuration received at 806. For example, if the UE does not have uplink or downlink traffic for a period of time, the UE may transition to DRX, at 810. While in DRX, the UE 802 monitors for PDCCH discontinuously, e.g., using on and off durations, such as described in connection with FIG. 5. While in a DRX mode, the UE 802 receives, from the network entity 804, DCI 812 within a DRX active time. A DRX active time refers to a time duration based on a timer (for example, the timer “drx-onDurationTimer” or “drx-InactivityTimer”) configured for the DRX group that is running. The DCI 812 indicates for the UE 802 to skip PDCCH monitoring for a duration of time within the DRX active time and without a resource assignment for downlink or uplink, e.g., the DCI does not include an allocation of resources scheduling uplink transmission or downlink reception for the UE. The UE 802 skips monitoring for a PDCCH during the duration of time (820), e.g., in response to receiving the DCI 812 indicating for the UE 802 to skip PDCCH monitoring for the duration of time within the DRX active time, and without a resource assignment for DL or UL.

The configuration 806 may be received in an RRC Configuration/Setup Signal for DRX, for example.

The DCI may be referred to as a non-scheduling DCI with a PDCCH skipping indication. The DRX mode may be a C-DRX mode, for example. The UE 802 can be indicated to skip PDCCH monitoring for a duration (820) by a DCI without a DL or UL assignment. In some aspects, the UE 802 may receive an ACK/NACK configuration 808 and be configured to perform or skip provision of ACK/NACK signals to network entity 804 in response to a non-scheduling DCI with a PDCCH skipping indication. That is, in one configuration, the UE 802 does not feed back ACK/NACK for DCI 812. In some aspects, the UE may receive an RRC configuration to skip ACK/NACK provision in response to a non-scheduling DCI with a PDCCH skipping indication. When ACK/NACK configuration 808 configures the UE 802 to skip provision of ACK/NACK signals to the network entity 804, an ACK/NACK 814 is not provided responsive to the UE 802 receiving the DCI 812, and the network entity 804 may skip processing ACK/NACK 814 signals, or ignore the lack of such signals, as required by the ACK/NACK configuration 808. In another configuration, the UE 802 may feed back ACK/NACK for DCI 812 as a default unless the network indicates for the UE to skip ACK/NACK feedback in response to a DCI indicating PDCCH skipping. For example, if there is no separate RRC configuration, the UE 802 may transmit the ACK/NACK 814 in a way similar to the ACK/NACK to a transmission configuration indication (TCI) indication DCI. When an ACK/NACK configuration 808 configures the UE 802 to provide ACK/NACK feedback to the network entity 804, the UE transmits the ACK/NACK 814 in response to the UE 802 receiving the DCI 812. The network entity 804 may process the received ACK/NACK 814 signals (816) to determine whether the UE received the indication to skip the PDCCH monitoring.

As illustrated at 818, the UE 802 skips monitoring for a PDCCH during the duration of time (820), and the network entity 804 may skip transmission of a PDCCH (818) during the duration of time that the network node indicated for the UE 802 is to skip PDCCH monitoring.

As the DCI 812 includes a PDCCH skipping indication without a resource assignment for DL or UL, the UE 802 does not transmit uplink transmission or perform downlink reception (822A) based on an absence of the resource assignment in the DCI 812. The UE may ignore, e.g., skip decoding of, the other fields in the DCI other than the PDCCH skipping indicator field that indicates for the UE 802 to skip the PDCCH monitoring (e.g., at 820). An example of a non-scheduling DCI is a DL DCI format 1_1 or 1_2, which may be referred to as a TCI indication DCI, that includes a PDCCH skipping indication field and without a DL assignment. Another example of a non-scheduling DCI includes an UL DCI format 0_1 or 0_2, which may be referred to as an UL scheduling DCI, with a PDCCH skipping indication field, and with a UL_SCH field set to 0 and a CSI request field set to 0. The DCI 812 thus indicates for the UE 802 to skip the PDCCH monitoring (e.g., at 820) by including an uplink scheduling DCI that includes the field for the indication to skip the PDCCH monitoring and without an uplink resource assignment. Upon detection of a DCI format 0_1 or 0_2 with ‘UL-SCH indicator’ set to ‘0’ and with a zero ‘CSI request’, the UE may ignore other fields in this DCI except the ‘PDCCH skipping indicator field,’ and the UE does not transmit the corresponding PUSCH as indicated by this DCI format 0_1 or 0_2.

Commensurately with the UE 802 being configured to skip uplink transmission or downlink reception (822A), the network entity 804 may likewise skip uplink reception or downlink transmission based on an absence of the resource assignment in the DCI 812 indicating for the UE to skip the PDCCH monitoring (e.g., at 820).

Additionally, or alternatively, to the DCI 812 being without an uplink or downlink resource allocation, the PDCCH skipping indication in the DCI may be applied for one or more of a set of CCs. That is, the UE 802 may skip the monitoring for the PDCCH (e.g., at 820) in one or more CCs including a component carrier in which the DCI 812. In some aspects, the UE may receive a PDCCH skipping configuration, e.g., configuration 806, that indicates the CCs to which the UE is to apply the PDCCH skipping indication. For instance, UE 802 may receive a configuration indicating to apply PDCCH skipping to one or more component carriers. When the UE receives the DCI in a component carrier indicating for the UE to skip PDCCH monitoring for a duration of time, to the UE skips monitoring for a PDCCH during the duration of time in the one or more component carriers indicated in the configuration.

In some aspects, the set of CCs may include each of the CCs that belong to a C-DRX group. In some aspects, the set of CCs may include a single CC in which the DCI is received. In some aspects, the set of CCs may include an RRC configured set of CCs.

In the context of PDCCH skipping for a set of CCs, during C-DRX active time in a C-DRX cycle, for example, the UE can be indicated to skip PDCCH monitoring for a duration by a DCI, and may skip PDCCH monitoring in the set of one or more CCs based on a previously received configuration. In a first example configuration, the PDCCH skipping is applied for all the CCs belonging to the same C-DRX group. In a second example configuration, the PDCCH skipping is applied only for the CC in which the DCI is received. In a third example configuration, the PDCCH skipping is applied to an RRC configured list of CCs, and if the UE receives a DCI indicating PDCCH skipping in a CC which belongs to a list of CCs, the UE applies the PDCCH skipping to all the CCs in the list of CCs. Additionally, or alternatively, during C-DRX active time in a C-DRX cycle, for example, the UE can be indicated to skip PDCCH monitoring for a duration by a DCI for multiple CCs, and the UE may apply the duration based on different configurations to accomplish this.

If the UE is skipping PDCCH monitoring in multiple CCs, the CCs may have a different SCS. The UE may determine the duration for the PDCCH monitoring skipping based on the SCS of the active DL BWP of the CC in which the DCI is received. The UE may determine the duration for the PDCCH monitoring skipping based on the smallest or largest SCS of active DL BWPs of all the CCs applied with PDCCH skipping. The UE may determine the duration for the PDCCH monitoring skipping based on the smallest or largest SCS of active DL BWPs of all the CCs belonging to the CDRX group. The UE may determine the duration for the PDCCH monitoring skipping based on the smallest or largest SCS of active DL BWPs of all the CCs in CA. The UE may determine the duration for the PDCCH monitoring skipping based on a reference SCS, e.g., which may be defined or configured by RRC configuration.

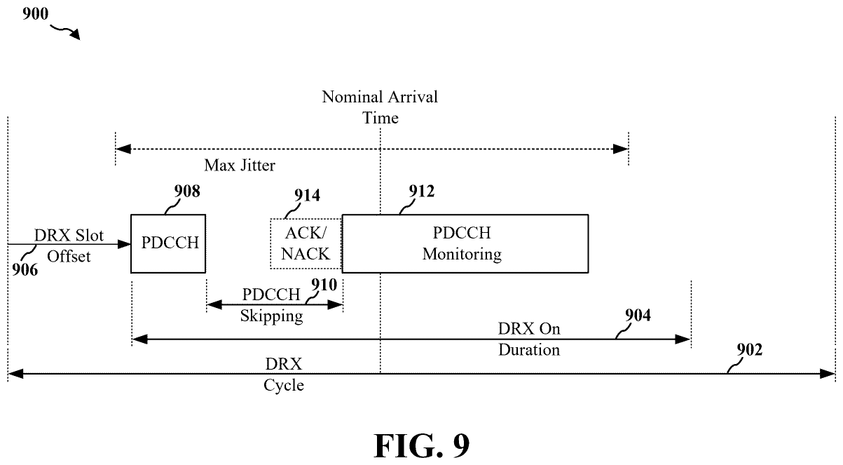

FIG. 9 is now described below, in the context of FIG. 8 as described above, and provides an example of a diagram 900 for non-scheduling downlink control information (DCI) for a PDCCH skipping indication, e.g., which may correspond to the DCI 812 in FIG. 8. Diagram 900 includes a DRX cycle 902 having a DRX on duration 904 that begins after a DRX slot offset 906 (also a “DRX start offset” in aspects), as described herein. The DCI, e.g., 812 is received in the PDCCH 908 with the DRX on duration and indicates for the UE to skip PDCCH monitoring for a period of time. FIG. 9 shows a PDCCH skipping portion 910 (e.g., period of time following the DCI reception) during which the UE skips monitoring for a PDCCH. FIG. 9 shows a PDCCH monitoring portion 912 in which the UE starts or returns to monitoring for PDCCH within the DRX on duration after the duration of PDCCH skipping has passed. FIG. 9 illustrates an example of a nominal arrival time and a span of maximum jitter with an active time comprising the DRX on duration 904, as well as other periods of time within the DRX cycle 902.

In some aspects, the DCI received in the PDCCH 908 may include a non-scheduling DCI for a PDCCH skipping indication, that is received in the C-DRX active time in the DRX cycle 902. The UE 802, for example, can be indicated to skip PDCCH monitoring as shown by PDCCH skipping portion 910, for a duration of time within the DRX active time, by the DCI without any DL or UL assignment during PDCCH skipping portion 910. As described in connection with FIG. 8, the UE may receive an ACK/NACK configuration to perform or skip provision of the ACK/NACK 914 signals to network entity, in aspects. That is, in one configuration, the UE may not feed back the ACK/NACK 914 signals for the DCI included in the PDCCH 908. For example, a separate RRC configuration may enable the UE to skip the ACK/NACK 914 provision. When the ACK/NACK configuration configures the UE to skip provision of the ACK/NACK 914 signals to a network entity, the ACK/NACK 914 is not provided responsive to the UE receiving the DCI, and the network entity is configured to not process the ACK/NACK 914 signals, or ignore the lack of such signals, as indicated by the ACK/NACK configuration.

In another configuration, the UE may feed back the ACK/NACK 914 signals for the DCI. For example, by default if there is no separate RRC configuration, the UE may feed back the ACK/NACK 914 signals in a way similar to the ACK/NACK to a TCI indication DCI. When the ACK/NACK configuration configures the UE to perform provision of the ACK/NACK 914 signals to the network entity, the ACK/NACK 914 is provided responsive to the UE receiving the DCI. The network entity is configured to process received the ACK/NACK 914 signals, if received thereby from the UE, as indicated by the ACK/NACK configuration.

In one configuration of non-scheduling DCI, for DL DCI format 1_1 or 1_2, a TCI indication DCI may include a PDCCH skipping indication field and may not include a DL assignment. The DCI thus indicates for the UE to skip the PDCCH monitoring by including the TCI indication DCI that includes a field for indication to skip the PDCCH monitoring and without a downlink resource assignment. In another configuration of non-scheduling DCI, for an UL DCI format 0_1 or 0_2, a UL scheduling DCI is configured with a PDCCH skipping indication field, and with a UL_SCH field set to 0 and a CSI request field set to 0. The DCI thus indicates for the UE to skip the PDCCH monitoring by including an uplink scheduling DCI that includes the field for the indication to skip the PDCCH monitoring and without an uplink resource assignment, in some aspects.

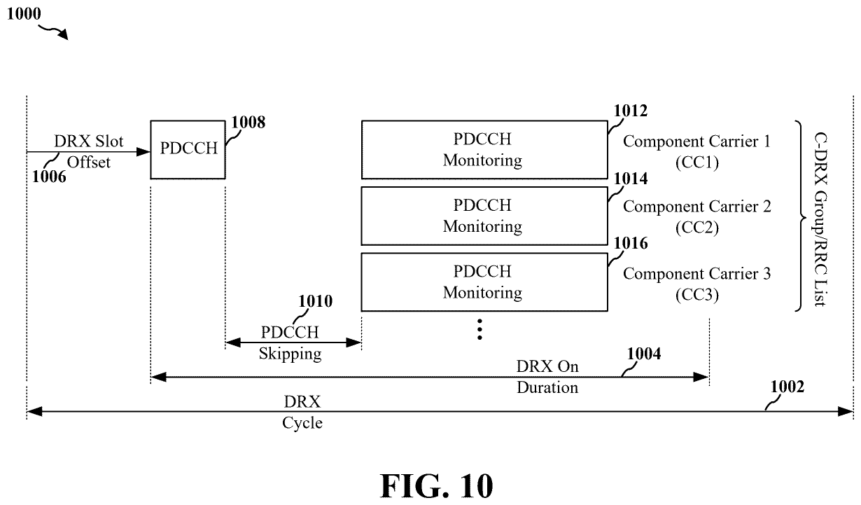

FIG. 10 is now described below, in the context of FIG. 8 as described above, and provides an example of a diagram 1000 for a PDCCH skipping indication for a set of component carriers (CCs). The aspects described in connection with FIG. 10 may be applied together with the aspects described in connection with FIG. 9, or may be applied independently of the non-scheduling aspects described in connection with FIG. 9. Diagram 1000 includes a DRX cycle 1002 having a DRX on duration 1004 that begins after a DRX slot offset 1006, as described herein. Also illustrated is PDCCH data including an initial PDCCH 1008 in a first CC (CC1), a PDCCH skipping portion 1010 (e.g., a duration of time during which the UE skips PDCCH monitoring based on a DCI received in the PDCCH 1008), and PDCCH monitoring on three CCs (e.g., CC1, CC2, and CC3), e.g., as illustrated at 1012, 1014, and 1016, which are shown in the context of a nominal arrival time and a span of maximum jitter with an active time comprising the DRX on duration 1004, as well as other periods of time within the DRX cycle 1002.

For a set of, or multiple, CCs, a non-scheduling DCI for a PDCCH skipping indication may be included in the initial PDCCH 1008 of a first CC (e.g., CC1) during the C-DRX active time in the DRX cycle 1002. A UE, e.g., UE 802, can be indicated to skip PDCCH monitoring as shown by PDCCH skipping portion 1010, for a duration of time within the DRX active time. In some aspects, the DCI may provide the indication without any DL or UL assignment during PDCCH skipping portion 1010. Additionally, the PDCCH skipping DCI in the PDCCH 1008 can be applicable to PDCCH monitoring on additional CCs, e.g., in addition to the CC on which the PDCCH skipping indication was received, as illustrated is diagram 1000 in FIG. 10.

Accordingly, various aspects may utilize a single PDCCH skipping DCI indication in the PDCCH 1008 in a single CC to provide an indication for a set of CCs, e.g., one or more CCs. That is, a UE may be configured to skip the monitoring for PDCCH in one or more CCs (e.g., as illustrated by PDCCH skipping portion 1010), including a CC in which the DCI is received. For instance, the UE may receive a configuration indicating to apply PDCCH skipping to one or more component carriers. When the UE receives a DCI in a component carrier indicating for the UE to skip PDCCH monitoring for a duration of time, to the UE may then skip monitoring for a PDCCH during the duration of time in the one or more component carriers based on the configuration.

In the context of PDCCH skipping for a set of CCs, during C-DRX active time in a C-DRX cycle, for example, the UE can be indicated to skip PDCCH monitoring for a duration by a DCI. In some aspects, UE may perform the PDCCH skipping for each of the CCs belonging to the same C-DRX group. In some aspects, the UE may perform the PDCCH skipping for the single CC in which the DCI is received. In some aspects, the UE may perform the PDCCH skipping for an RRC configured list of CCs, and if the UE receives a DCI indicating PDCCH skipping in a CC which belongs to a list of CCs, the UE applies the PDCCH skipping to each of the CCs in the list of CCs. Additionally, or alternatively, during C-DRX active time in a C-DRX cycle, for example, the UE can be indicated to skip PDCCH monitoring for a duration by a DCI for multiple CCs, and the UE may apply the duration based on different configurations to accomplish this.

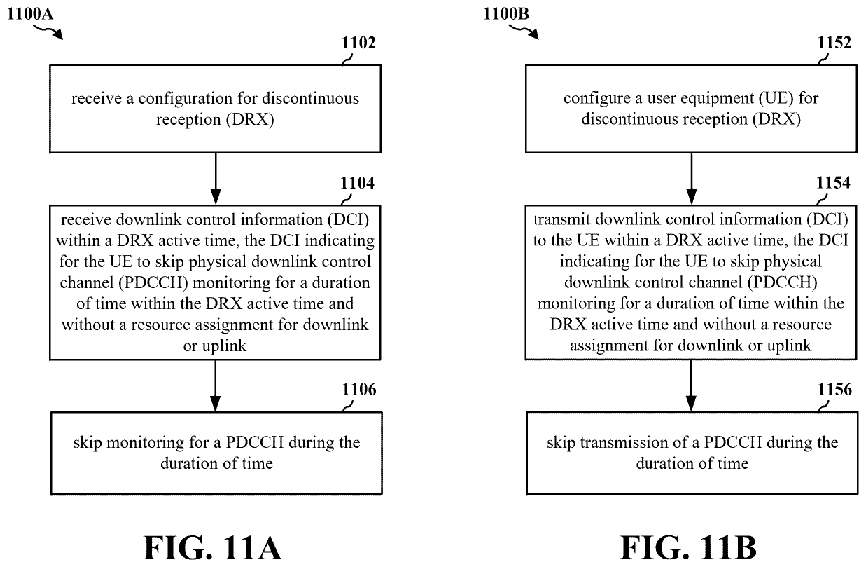

FIG. 11A is an example flowchart 1100A of a method of wireless communication. The method may be performed by a UE (e.g., the UE 104, 350, 802; the apparatus 1304; etc.). The method may improve power savings at a UE, e.g., by providing PDCCH monitoring skipping in a DCI that does not schedule uplink or downlink communication.

At 1102, the UE receives a configuration for DRX. For example, 1102 may be performed by component 198, as shown in FIGS. 1, 3, and 13, of the UE (e.g., the UE 104; the UE 802; the apparatus 1304; etc.). FIG. 8 illustrates an example of a UE receiving a configuration (806) for DRX from a network entity (e.g., the base station 102; the network entity 804; the network entity 1402; etc.) as shown in FIG. 8 described above. FIG. 5 illustrates example aspects of a DRX configuration.

At 1104, the UE receives DCI within a DRX active time, the DCI indicating for the UE to skip PDCCH monitoring for a duration of time within the DRX active time and without a resource assignment for downlink or uplink. The DRX active time may correspond to a DRX on duration and additional time, for example. For instance, 1104 may be performed by component 198, as shown in FIGS. 1, 3, and 13, of the UE (e.g., the UE 104; the UE 802; the apparatus 1304; etc.). FIG. 8 illustrates an example of a UE receiving a DCI from a network entity (e.g., the base station 102; the network entity 804; the network entity 1402; etc.) as shown in FIG. 8 (812) described above, and indicate the duration of time as a PDCCH skipping portion (e.g., 910; 1010). FIGS. 9 and 10 illustrate example aspects of PDCCH skipping. In aspects, the DCI may be included in an initial PDCCH (e.g., 908; 1008) in a DRX on duration (e.g., 904; 1004) of an active portion of a DRX cycle (e.g., 902; 1002), as shown in FIGS. 9 and 10. In some aspects, the DCI indicating for the UE to skip the PDCCH monitoring may include a transmission configuration indication (TCI) indication DCI (e.g., a DCI format 0_1 or 0_2) including a field for indication to skip the PDCCH monitoring and without a downlink resource assignment. In some aspects, the DCI indicating for the UE to skip the PDCCH monitoring may include an uplink scheduling DCI (e.g., a DCI format 0_1 or 0_2) including the field for the indication to skip the PDCCH monitoring and without an uplink resource assignment.

At 1106, the UE skips monitoring for a PDCCH during the duration of time. For example, 1106 may be performed by component 198, as shown in FIGS. 1, 3, and 13, of the UE (e.g., the UE 104; the UE 802; the apparatus 1304; etc.). FIGS. 8, 9, and 10 illustrate example aspects of a UE skipping PDCCH monitoring in response to a DCI indication. In some aspects, the UE may skip the monitoring for the PDCCH in one or more component carriers including a component carrier in which the DCI is received based on a PDCCH skipping configuration.

The UE may further skip uplink transmission or downlink reception based on an absence of the resource assignment in the DCI indicting for the UE to skip the PDCCH monitoring. In some aspects, the UE may transmit an ACK feedback in response to reception of the DCI indicating for the UE to skip the PDCCH monitoring. In some aspects, the UE may skip transmission of an ACK feedback in response to reception of the DCI indicating for the UE to skip the PDCCH monitoring. In some aspects, the UE may receive, prior to reception of the DCI, an RRC configuration indicating for the UE to transmit or skip transmission of ACK/NACK feedback in response to the reception of the DCI indicating for the UE to skip the PDCCH monitoring.

FIG. 11B is an example flowchart 1152 of a method of wireless communication. The method 1100B may be performed by a network entity (e.g., the base station 102, 310; the CU 110, the DU 130; the RU 140; the network entity 804; the network entity 1402; etc.). The method may enable a network device to assist a UE in power savings, e.g., by providing PDCCH monitoring skipping in a DCI that does not schedule uplink or downlink communication.

At 1152, the network entity configures a UE for DRX. For example, 1152 may be performed by component 199, as shown in FIGS. 1, 3, and 14, of the network entity (e.g., the base station 102; the network entity 804; the network entity 1402; etc.). FIG. 8 illustrates an example of a network entity that transmits a configuration (806) for DRX to a UE (e.g., the base station 102; the network entity 804; the network entity 1402; etc.) to a UE (e.g., the UE 104; the UE 802; the apparatus 1304; etc.) as shown in FIG. 8 described above. FIG. 5 illustrates various aspects of a DRX cycle.

At 1154, the network entity transmits DCI to the UE within a DRX active time, the DCI indicating for the UE to skip PDCCH monitoring for a duration of time within the DRX active time and without a resource assignment for downlink or uplink. For instance, 1154 may be performed by component 199, as shown in FIGS. 1, 3, and 14, of the network entity (e.g., the base station 102; the network entity 804; the network entity 1402; etc.). FIG. 8 illustrates an example of a network entity transmitting DCI to a UE indicating the duration of time to skip PDCCH monitoring (e.g., 910; 1010), as shown in FIGS. 9 and 10 and described above. In aspects, the DCI may be included in a PDCCH (e.g., 908; 1008) in a DRX on duration (e.g., 904; 1004) of an active portion of a DRX cycle (e.g., 902; 1002), as shown in FIGS. 9 and 10.

At 1156, the network entity skips transmission of a PDCCH during the duration of time. For example, 1156 may be performed by component 199, as shown in FIGS. 1, 3, and 14, of the network entity (e.g., the base station 102; the network entity 804; the network entity 1402; etc.). FIGS. 9 and 10 illustrate examples of a PDCCH skipping portion (e.g., 910; 1010) that correspond to the duration of time for skipping transmission of the PDCCH (as also shown at 820 in FIG. 8).

In some aspects, the network node may skip uplink reception or downlink transmission based on an absence of the resource assignment in the DCI indicating for the UE to skip the PDCCH monitoring, e.g., at 822B.

In some aspects, the network node may transmit, prior to transmission of the DCI, a RRC configuration indicating for the UE to transmit or skip transmission of ACK/NACK feedback in response to the reception of the DCI indicating for the UE to skip the PDCCH monitoring.

The DCI indicating for the UE to skip the PDCCH monitoring may include a TCI indication DCI including a field for indication to skip the PDCCH monitoring and without a downlink resource assignment. The DCI indicating for the UE to skip the PDCCH monitoring may include an uplink scheduling DCI including the field for the indication to skip the PDCCH monitoring and without an uplink resource assignment.

In some aspects, the network node may configure the UE to skip monitoring for the PDCCH in one or more component carriers including a component carrier in which the DCI is received based on a PDCCH skipping configuration.

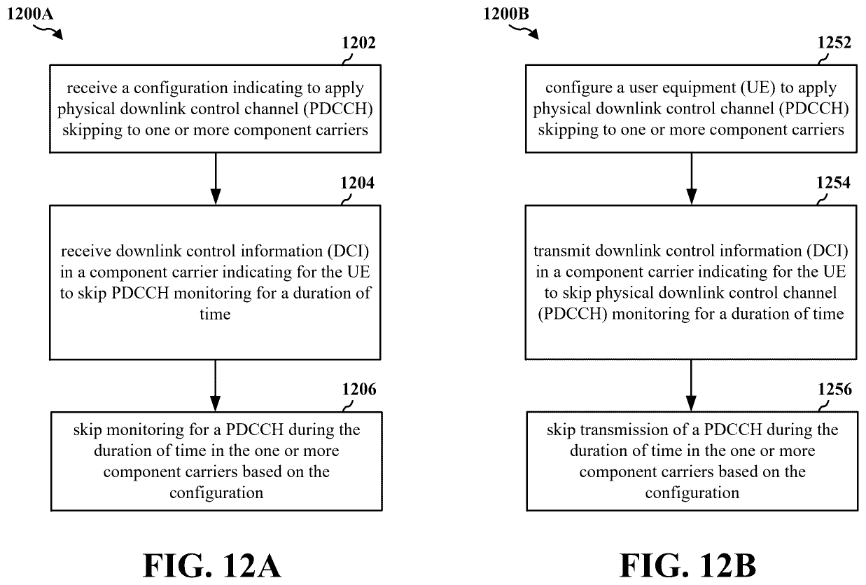

FIG. 12A is an example flowchart 1200A of a method of wireless communication. The method may improve power savings at a UE, e.g., by providing PDCCH monitoring skipping in a DCI that provides an indication to skip PDCCH monitoring on a set of CCs.

The method may be performed by a UE (e.g., the UE 104; the UE 802; the apparatus 1304; etc.). At 1202, the UE receives a configuration indicating to apply a PDCCH skipping to one or more component carriers. For example, 1202 may be performed by component 198, as shown in FIGS. 1, 3, and 13, of the UE (e.g., the UE 104; the UE 802; the apparatus 1304; etc.). In some aspects the UE may receive a DRX configuration, the duration of time being a period of time within an active time of the DRX configuration. FIG. 8 illustrates an example of a UE receiving a configuration (806) for DRX from a network entity (e.g., the base station 102; the network entity 804; the network entity 1402; etc.). In some aspects, the configuration may indicate for the UE to apply the PDCCH skipping to each component carrier in a discontinuous reception (DRX) group, and the at least one processor is configured to skip monitoring for the PDCCH during the duration of time in each of the DRX group that includes the component carrier in which the DCI is received. In some aspects, the configuration indicates for the UE to apply the PDCCH skipping for a single component carrier in which the DCI is received. In some aspects, the configuration indicates a group of component carriers for the PDCCH skipping, and the at least one processor is configured to skip monitoring for the PDCCH during the duration of time in each of the component carriers in the group of component carriers configured for the PDCCH skipping.

At 1204, the UE receives DCI in a component carrier indicating for the UE to skip PDCCH monitoring for a duration of time. For instance, 1204 may be performed by component 198, as shown in FIGS. 1, 3, and 13, of the UE (e.g., the UE 104; the UE 802; the apparatus 1304; etc.). FIG. 8 illustrates an example of a DCI that a UE receives from a network entity (e.g., the base station 102; the network entity 804; the network entity 1402; etc.), the DCI indicating for the UE to skip PDCCH monitoring for a (e.g., 1010) in a CC (CC1), as shown in FIG. 10 and described above. In some aspects, the DCI may be included in a PDCCH (e.g., 1008) in a DRX on duration (e.g., 1004) of an active portion of a DRX cycle (e.g., 1002), as shown in FIG. 10. In some aspects, the DCI may not include a resource allocation for uplink or downlink.

At 1206, the UE skips monitoring for a PDCCH during the duration of time in the one or more component carriers based on the configuration. For example, 1206 may be performed by component 198, as shown in FIGS. 1, 3, and 13, of the UE (e.g., the UE 104; the UE 802; the apparatus 1304; etc.). FIGS. 8, 9 and 10 illustrate example aspects of a UE skipping PDCCH monitoring on one or more CCs. In some aspects, the UE may skip monitoring for the PDCCH in multiple component carriers, and the duration of time is based on one of: a subcarrier spacing (SCS) of an active downlink bandwidth part (BWP) of the component carrier in which the DCI is received, a smallest SCS of each of the active downlink BWPs of the multiple component carriers, a largest SCS of each of the active downlink BWPs of the multiple component carriers, or a reference SCS.

FIG. 12B is an example flowchart 1200B of a method of wireless communication.

The method may be performed by a network entity (e.g., the base station 102; the CU 110; the DU 130; the RU 140; the network entity 804; the network entity 1402; etc.). The method may improve power savings at a UE, e.g., by providing PDCCH monitoring skipping in a DCI that provides an indication to skip PDCCH monitoring on a set of CCs.

At 1252, the network entity configures a UE to apply PDCCH skipping to one or more component carriers. For example, 1252 may be performed by component 199, as shown in FIGS. 1, 3, and 14, of the network entity (e.g., the base station 102; the network entity 804; the network entity 1402; etc.). The configuration (806) for DRX may be transmitted from the network entity (e.g., the base station 102; the network entity 804; the network entity 1402; etc.) to a UE (e.g., the UE 104; the UE 802; the apparatus 1304; etc.) as shown in FIG. 8 described above, and configure the UE to apply PDCCH skipping to a set of, or multiple, CCs.

At 1254, the network entity transmits DCI in a component carrier indicating for the UE to skip PDCCH monitoring for a duration of time. For instance, 1254 may be performed by component 199, as shown in FIGS. 1, 3, and 14, of the network entity (e.g., the base station 102; the network entity 804; the network entity 1402; etc.). The DCI may be transmitted in a CC (e.g., CC1 of FIG. 10) to a UE (e.g., the UE 104; the UE 802; the apparatus 1304; etc.) as shown in FIG. 8 (812) described above, and may indicate the duration of time (e.g., 1010), as shown in FIG. 10 and described above. In aspects, the DCI may be in a PDCCH (e.g., 1008 in CC1) during a DRX on duration (e.g., 1004) of an active portion of a DRX cycle (e.g., 902; 1002), as shown in FIGS. 9 and 10. In some aspects, the DCI may not include a resource allocation for uplink or downlink.

At 1256, the network entity skips transmission of a PDCCH during the duration of time in the one or more component carriers based on the configuration. For example, 1256 may be performed by component 199, as shown in FIGS. 1, 3, and 14, of the network entity (e.g., the base station 102; the network entity 804; the network entity 1402; etc.). FIGS. 8, 9, and 10 illustrate various aspects of PDCCH skipping. As an example, the DCI provided only in the PDCCH one a single CC (e.g., 1008 in CC1) enables the skipping of PDCCH in configurable sets of CCs (e.g., CC1, CC2, and/or CC3, etc.).

In some aspects, the network node may configure the UE for DRX, the duration of time being a period of time within an active time of the DRX configuration. The configuration may indicate for the UE to apply the PDCCH skipping to each component carrier in a DRX group. The configuration may indicate for the UE to apply the PDCCH skipping for a single component carrier in which the DCI is received. The configuration may indicate a group of component carriers for the PDCCH skipping, and the at least one processor is configured to skip transmission of the PDCCH during the duration of time in each of the component carriers in the group of component carriers configured for the PDCCH skipping.

In some aspects, the network node may skip transmission of the PDCCH in multiple component carriers, and the duration of time is based on one of: an SCS of an active downlink BWP of the component carrier in which the DCI is received, a smallest SCS of each of the active downlink BWPs of the multiple component carriers, a largest SCS of each of the active downlink BWPs of the multiple component carriers, or a reference SCS.

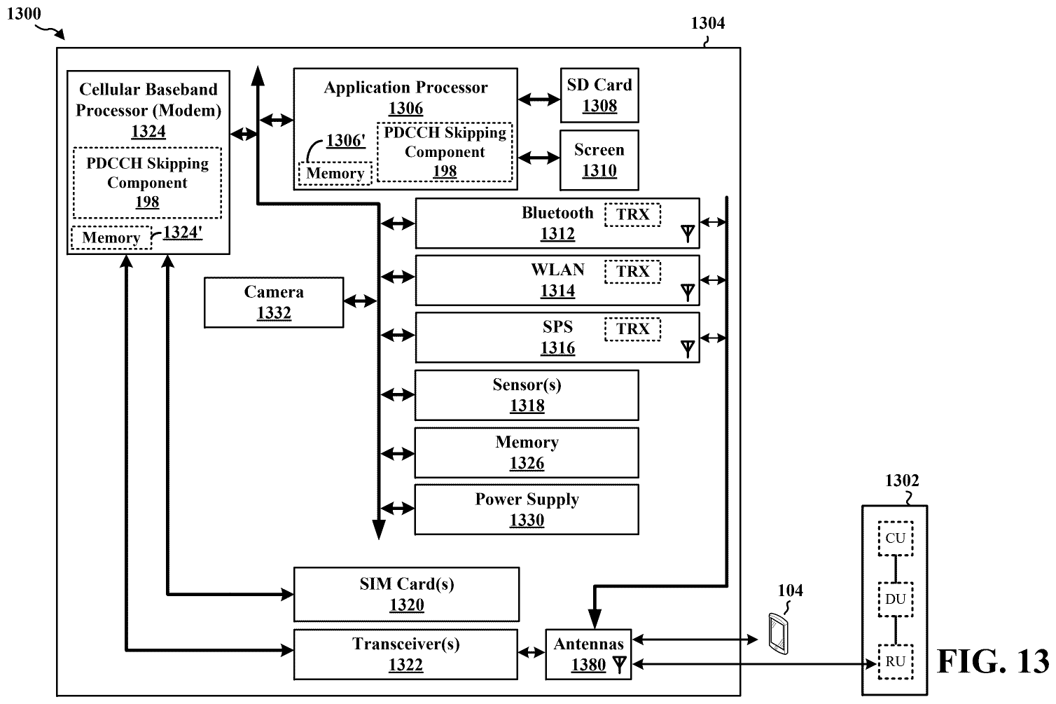

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 may be configured to receive a configuration for DRX, to receive DCI within a DRX active time, the DCI indicating for the UE to skip PDCCH monitoring for a duration of time within the DRX active time and without a resource assignment for downlink or uplink, and to skip monitoring for a PDCCH during the duration of time. The component 198 may be configured to receive a configuration indicating to apply PDCCH skipping to one or more component carriers, to receive DCI in a component carrier indicating for the UE to skip PDCCH monitoring for a duration of time, and to skip monitoring for a PDCCH during the duration of time in the one or more component carriers based on the configuration. The component 198 may be configured to perform any of the aspects described in connection with FIG. 11A, 12A, and/or performed by the UE in FIG. 8. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving a configuration for DRX; means for receiving DCI within a DRX active time, the DCI indicating for the UE to skip PDCCH monitoring for a duration of time within the DRX active time and without a resource assignment for downlink or uplink; and means for skipping monitoring for a PDCCH during the duration of time. In some aspects, the apparatus 1304, and in particular the cellular baseband processor 1324 and/or the application processor 1306, may include means for receiving a configuration indicating to apply PDCCH skipping to one or more component carriers; means for receiving DCI in a component carrier indicating for the UE to skip PDCCH monitoring for a duration of time; and means for skipping monitoring for a PDCCH during the duration of time in the one or more component carriers based on the configuration. The apparatus 1304 may further include means for performing any of the aspects described in connection with FIG. 11A, 12A, and/or performed by the UE in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

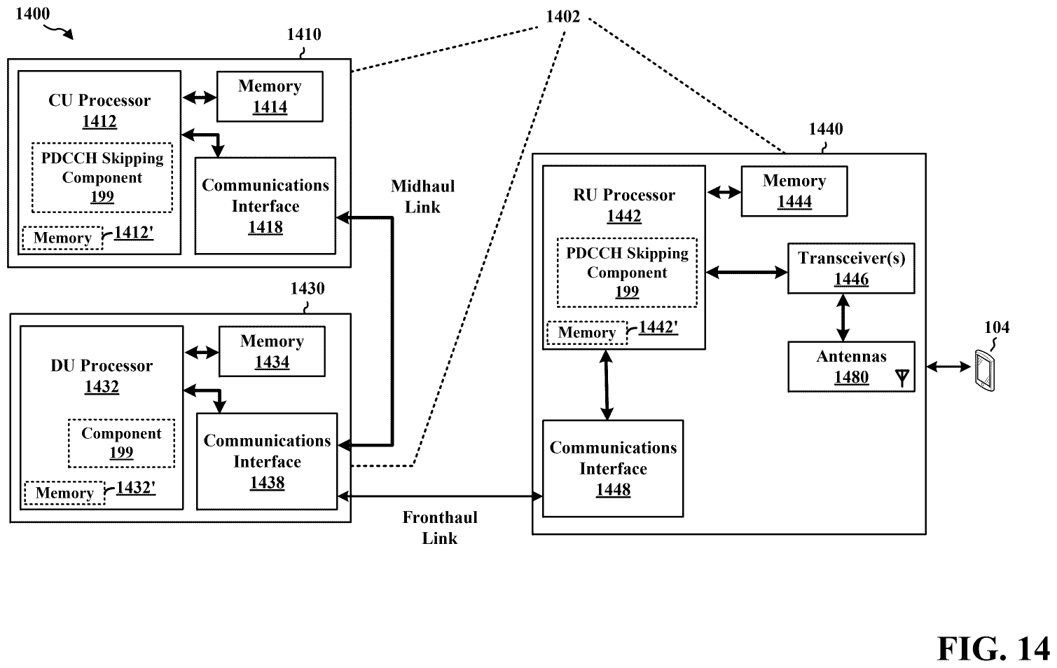

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE for DRX, to transmit DCI to the UE within a DRX active time, the DCI indicating for the UE to skip PDCCH monitoring for a duration of time within the DRX active time and without a resource assignment for downlink or uplink, and to skip transmission of a PDCCH during the duration of time. The component 199 may also be configured to configure a UE to apply PDCCH skipping to one or more component carriers, to transmit DCI in a component carrier indicating for the UE to skip PDCCH monitoring for a duration of time and to skip transmission of a PDCCH during the duration of time in the one or more component carriers based on the configuration. The component 199 may be further configured to perform any of the aspects described in connection with FIG. 11B, 12B, and/or performed by the network entity in FIG. 8. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for configuring a UE for DRX; means for transmitting DCI to the UE within a DRX active time, the DCI indicating for the UE to skip PDCCH monitoring for a duration of time within the DRX active time and without a resource assignment for downlink or uplink; and means for skipping transmission of a PDCCH during the duration of time. The network entity 1402 may include means for configuring a UE to apply PDCCH skipping to one or more component carriers; means for transmitting in a component carrier indicating for the UE to skip PDCCH monitoring for a duration of time; and means for skipping transmission of a PDCCH during the duration of time in the one or more component carriers based on the configuration. The network entity may further include means for performing any of the aspects described in connection with FIG. 11B, 12B, and/or performed by the network entity in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Aspects herein relate to PDCCH skipping without channel assignments, as well as on multiple CCs. On durations of active DRX cycles require DL and/or UL assignments to be made, which requires power of the UE to perform. Additionally, PDCCH skipping DCI is only indicated for a single CC. The described aspects provide for power reductions during C-DRX on durations via PDCCH skipping DCI that specifies a portion of PDCCH monitoring to be skipped in the on duration without UL or DL assignments. The described aspects also provide for PDCCH skipping DCI that specifies one or more CCs in CA from a single received instance of DCI in a single CC.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, comprising receiving a configuration for DRX, receiving DCI within a DRX active time, the DCI indicating for the UE to skip PDCCH monitoring for a duration of time within the DRX active time and without a resource assignment for downlink or uplink, and skipping monitoring for a PDCCH during the duration of time.
Aspect 2 is the method of aspect 1, further comprising skipping uplink transmission or downlink reception based on an absence of the resource assignment in the DCI indicating for the UE to skip the PDCCH monitoring.
Aspect 3 is the method of any of aspects 1 and 2, further comprising transmitting an ACK feedback in response to reception of the DCI indicating for the UE to skip the PDCCH monitoring.
Aspect 4 is the method of any of aspects 1 and 2, further comprising skipping transmission of an ACK feedback in response to reception of the DCI indicating for the UE to skip the PDCCH monitoring.
Aspect 5 is the method of any of aspects 1 to 4, further comprising receiving, prior to reception of the DCI, a RRC configuration indicating for the UE to transmit or skip transmission of ACK/NACK feedback in response to the reception of the DCI indicating for the UE to skip the PDCCH monitoring.
Aspect 6 is the method of any of aspects 1 to 5, where the DCI indicating for the UE to skip the PDCCH monitoring includes one of: a TCI indication DCI including a field for indication to skip the PDCCH monitoring and without a downlink resource assignment, or an uplink scheduling DCI including the field for the indication to skip the PDCCH monitoring and without an uplink resource assignment.
Aspect 7 is the method of any of aspects 1 to 6, further comprising skipping the monitoring for the PDCCH in one or more component carriers including a component carrier in which the DCI is received based on a PDCCH skipping configuration.
Aspect 8 is the method of any of aspects 1 to 7, further comprising receiving the DCI via at least one transceiver, of the UE, which is coupled to at least one processor of the UE.
Aspect 9 is a method of wireless communication at a UE, comprising receiving a configuration indicating to apply PDCCH skipping to one or more component carriers, receiving DCI in a component carrier indicating for the UE to skip PDCCH monitoring for a duration of time, and skipping monitoring for a PDCCH during the duration of time in the one or more component carriers based on the configuration.
Aspect 10 is the method of aspect 9, further comprising receiving a DRX configuration, the duration of time being a period of time within an active time of the DRX configuration.
Aspect 11 is the method of any of aspects 9 and 10, where the configuration indicates for the UE to apply the PDCCH skipping to each component carrier in a DRX group, and the method further comprises skipping the monitoring for the PDCCH during the duration of time in each of the DRX group that includes the component carrier in which the DCI is received.
Aspect 12 is the method of any of aspects 9 and 10, where the configuration indicates for the UE to apply the PDCCH skipping for a single component carrier in which the DCI is received.
Aspect 13 is the method of any of aspects 9 and 10, where the configuration indicates a group of component carriers for the PDCCH skipping, and the method further comprises skipping monitoring for the PDCCH during the duration of time in each component carriers in the group of component carriers configured for the PDCCH skipping.
Aspect 14 is the method of any of aspects 9 to 11 and 13, further comprising skipping the monitoring for the PDCCH in multiple component carriers, and where the duration of time is based on one of: a SCS of an active downlink bandwidth part BWP of the component carrier in which the DCI is received, a smallest SCS of each active downlink BWP of the multiple component carriers, a largest SCS of each active downlink BWP of the multiple component carriers, or a reference SCS.
Aspect 15 is the method of any of aspects 9 to 14, where the DCI does not include a resource allocation for uplink or downlink.
Aspect 16 is the method of any of aspects 9 to 15, further comprising receiving the DCI via at least one transceiver, of the UE, which is coupled to at least one processor of the UE.
Aspect 17 is a method of wireless communication at a network node, comprising configuring a UE for DRX, transmitting DCI to the UE within a DRX active time, the DCI indicating for the UE to skip PDCCH monitoring for a duration of time within the DRX active time and without a resource assignment for downlink or uplink, and skipping transmission of a PDCCH during the duration of time.
Aspect 18 is a method of aspect 17, further comprising skipping uplink reception or downlink transmission based on an absence of the resource assignment in the DCI indicating for the UE to skip the PDCCH monitoring.
Aspect 19 is a method of any of aspects 17 and 18, further comprising transmitting, prior to transmission of the DCI, a RRC configuration indicating for the UE to transmit or skip transmission of an ACK/NACK feedback in response to reception of the DCI indicating for the UE to skip the PDCCH monitoring.
Aspect 20 is a method of any of aspects 17 to 19, where the DCI indicating for the UE to skip the PDCCH monitoring includes one of: a TCI indication DCI including a field for indication to skip the PDCCH monitoring and without a downlink resource assignment, or an uplink scheduling DCI including the field for the indication to skip the PDCCH monitoring and without an uplink resource assignment.
Aspect 21 is a method of any of aspects 17 to 20, further comprising configuring the UE to skip monitoring for the PDCCH in one or more component carriers including a component carrier in which the DCI is received based on a PDCCH skipping configuration.
Aspect 22 is a method of any of aspects 17 to 21, further comprising transmitting the DCI via at least one transceiver, of the network node, which is coupled to at least one processor of the network node.
Aspect 23 is a method of wireless communication at a network node, comprising configuring a UE to a configuration to apply PDCCH skipping to one or more component carriers, transmitting DCI in a component carrier indicating for the UE to skip PDCCH monitoring for a duration of time, and skipping transmission of a PDCCH during the duration of time in the one or more component carriers based on the configuration.
Aspect 24 is the method of aspect 23, further comprising configuring the UE for DRX, the duration of time being a period of time within an active time of the DRX configuration.
Aspect 25 is the method of any of aspects 23 and 24, where the configuration indicates for the UE to apply the PDCCH skipping to each component carrier in a DRX group.
Aspect 26 is the method of any of aspects 23 and 24, where the configuration indicates for the UE to apply the PDCCH skipping for a single component carrier in which the DCI is received.
Aspect 27 is the method of any of aspects 23 and 24, where the configuration indicates a group of component carriers for the PDCCH skipping, and the method further comprises skipping transmission of the PDCCH during the duration of time in each component carrier in the group of component carriers configured for the PDCCH skipping.
Aspect 28 is the method of any of aspects 23 to 25 and 27, further comprising skipping transmission of the PDCCH in multiple component carriers, and where the duration of time is based on one of: a SCS of an active downlink BWP of the component carrier in which the DCI is received, a smallest SCS of each active downlink BWP of the multiple component carriers, a largest SCS of each active downlink BWP of the multiple component carriers, or a reference SCS.
Aspect 29 is the method of any of aspects 23 to 28, where the DCI does not include a resource allocation for uplink or downlink.
Aspect 30 is a method of any of aspects 23 to 29, further comprising transmitting the DCI via at least one transceiver, of the network node, which is coupled to at least one processor of the network node.
Aspect 31 is an apparatus for wireless communication at a UE, comprising means to perform the method of any of aspects 1 to 16.
Aspect 32 is an apparatus for wireless communication at a network node, comprising means to perform the method of any of aspects 17 to 30.
Aspect 33 is a computer-readable medium storing computer executable code at a UE, the code when executed by a processor causes the processor to perform the method of any of aspects 1 to 16.
Aspect 33 is a computer-readable medium storing computer executable code at a UE, the code when executed by a processor causes the processor to perform the method of any of aspects 17 to 30.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration for discontinuous reception (DRX);
receive downlink control information (DCI) within a DRX active time, the DCI indicating for the UE to skip physical downlink control channel (PDCCH) monitoring for a duration of time within the DRX active time and without a resource assignment for downlink or uplink; and
skip monitoring for a PDCCH during the duration of time.

2. The apparatus of claim 1, wherein the at least one processor is further configured to:
skip uplink transmission or downlink reception based on an absence of the resource assignment in the DCI indicating for the UE to skip the PDCCH monitoring.

3. The apparatus of claim 1, wherein the at least one processor is further configured to:
transmit an acknowledgment (ACK) feedback in response to reception of the DCI indicating for the UE to skip the PDCCH monitoring.

4. The apparatus of claim 1, wherein the at least one processor is further configured to:
skip transmission of an acknowledgment (ACK) feedback in response to reception of the DCI indicating for the UE to skip the PDCCH monitoring.

5. The apparatus of claim 1, wherein the at least one processor is further configured to:
receive, prior to reception of the DCI, a radio resource control (RRC) configuration indicating for the UE to transmit or skip transmission of acknowledgment/negative acknowledgment (ACK/NACK) feedback in response to the reception of the DCI indicating for the UE to skip the PDCCH monitoring.

6. The apparatus of claim 1, wherein the DCI indicating for the UE to skip the PDCCH monitoring includes one of:
a transmission configuration indication (TCI) indication DCI including a field for indication to skip the PDCCH monitoring and without a downlink resource assignment, or
an uplink scheduling DCI including the field for the indication to skip the PDCCH monitoring and without an uplink resource assignment.

7. The apparatus of claim 1, wherein the at least one processor is configured to skip the monitoring for the PDCCH in one or more component carriers including a component carrier in which the DCI is received based on a PDCCH skipping configuration.

8. The apparatus of claim 1, further comprising:
at least one transceiver coupled to the at least one processor and configured to receive the DCI.

9. An apparatus for wireless communication at a user equipment (UE), comprising:
a memory; and
at least one processor coupled to the memory and, based at least in part on information stored in the memory, the at least one processor is configured to:
receive a configuration indicating to apply physical downlink control channel (PDCCH) skipping to one or more component carriers;
receive downlink control information (DCI) in a component carrier indicating for the UE to skip PDCCH monitoring for a duration of time; and
skip monitoring for a PDCCH during the duration of time in the one or more component carriers based on the configuration.

10. The apparatus of claim 9, wherein the at least one processor is further configured to:
receive a discontinuous reception (DRX) configuration, the duration of time being a period of time within an active time of the DRX configuration.

11. The apparatus of claim 9, wherein the configuration indicates for the UE to apply the PDCCH skipping to each component carrier in a discontinuous reception (DRX) group, and the at least one processor is configured to skip the monitoring for the PDCCH during the duration of time in each of the DRX group that includes the component carrier in which the DCI is received.

12. The apparatus of claim 9, wherein the configuration indicates for the UE to apply the PDCCH skipping for a single component carrier in which the DCI is received.

13. The apparatus of claim 9, wherein the configuration indicates a group of component carriers for the PDCCH skipping, and the at least one processor is configured to skip monitoring for the PDCCH during the duration of time in each component carriers in the group of component carriers configured for the PDCCH skipping.

14. The apparatus of claim 9, wherein the at least one processor is configured to skip the monitoring for the PDCCH in multiple component carriers, and the duration of time is based on one of:
a subcarrier spacing (SCS) of an active downlink bandwidth part (BWP) of the component carrier in which the DCI is received,
a smallest SCS of each active downlink BWP of the multiple component carriers,
a largest SCS of each active downlink BWP of the multiple component carriers, or
a reference SCS.

15. The apparatus of claim 9, wherein the DCI does not include a resource allocation for uplink or downlink.

16. The apparatus of claim 9, further comprising:
at least one transceiver coupled to the at least one processor and configured to receive the DCI.

17. An apparatus for wireless communication at a network node, comprising:
a memory; and
at least one processor coupled to the memory and, based at least in part on information stored in the memory, the at least one processor is configured to:
configure a user equipment (UE) for discontinuous reception (DRX);
transmit downlink control information (DCI) to the UE within a DRX active time, the DCI indicating for the UE to skip physical downlink control channel (PDCCH) monitoring for a duration of time within the DRX active time and without a resource assignment for downlink or uplink; and
skip transmission of a PDCCH during the duration of time.

18. The apparatus of claim 17, wherein the at least one processor is further configured to:
skip uplink reception or downlink transmission based on an absence of the resource assignment in the DCI indicating for the UE to skip the PDCCH monitoring.

19. The apparatus of claim 17, wherein the at least one processor is further configured to:
transmit, prior to transmission of the DCI, a radio resource control (RRC) configuration indicating for the UE to transmit or skip transmission of an acknowledgment/negative acknowledgment (ACK/NACK) feedback in response to reception of the DCI indicating for the UE to skip the PDCCH monitoring.

20. The apparatus of claim 17, wherein the DCI indicating for the UE to skip the PDCCH monitoring includes one of:
a transmission configuration indication (TCI) indication DCI including a field for indication to skip the PDCCH monitoring and without a downlink resource assignment, or
an uplink scheduling DCI including the field for the indication to skip the PDCCH monitoring and without an uplink resource assignment.

21. The apparatus of claim 17, wherein the at least one processor is further configured to:
configure the UE to skip monitoring for the PDCCH in one or more component carriers including a component carrier in which the DCI is received based on a PDCCH skipping configuration.

22. The apparatus of claim 17, further comprising:
at least one transceiver coupled to the at least one processor and configured to transmit the DCI.

23. An apparatus for wireless communication at a network node, comprising:
a memory; and
at least one processor coupled to the memory and, based at least in part on information stored in the memory, the at least one processor is configured to:
configure a user equipment (UE) to a configuration to apply physical downlink control channel (PDCCH) skipping to one or more component carriers;
transmit downlink control information (DCI) in a component carrier indicating for the UE to skip PDCCH monitoring for a duration of time; and
skip transmission of a PDCCH during the duration of time in the one or more component carriers based on the configuration.

24. The apparatus of claim 23, wherein the at least one processor is further configured to:
configure the UE for discontinuous reception (DRX), the duration of time being a period of time within an active time of the DRX configuration.

25. The apparatus of claim 23, wherein the configuration indicates for the UE to apply the PDCCH skipping to each component carrier in a discontinuous reception (DRX) group.

26. The apparatus of claim 23, wherein the configuration indicates for the UE to apply the PDCCH skipping for a single component carrier in which the DCI is received.

27. The apparatus of claim 23, wherein the configuration indicates a group of component carriers for the PDCCH skipping, and the at least one processor is configured to skip transmission of the PDCCH during the duration of time in each component carrier in the group of component carriers configured for the PDCCH skipping.

28. The apparatus of claim 23, wherein the at least one processor is configured to skip transmission of the PDCCH in multiple component carriers, and the duration of time is based on one of:
a subcarrier spacing (SCS) of an active downlink bandwidth part (BWP) of the component carrier in which the DCI is received,
a smallest SCS of each active downlink BWP of the multiple component carriers,
a largest SCS of each active downlink BWP of the multiple component carriers, or
a reference SCS.

29. The apparatus of claim 23, wherein the DCI does not include a resource allocation for uplink or downlink.

30. The apparatus of claim 23, further comprising:
at least one transceiver coupled to the at least one processor and configured to transmit the DCI.
